(19) United States
(12) Patent Application Publication
(10) Pub. No.: US 2026/0017536 A1
(43) Pub. Date: Jan. 15, 2026

(54) DYNAMIC EXPERTISE PROFILING THROUGH HISTORICAL PROMPT-DRIVEN REFINEMENT INTERACTIONS

(71) Applicant: INTERNATIONAL BUSINESS MACHINES CORPORATION, ARMONK, NY (US)

(72) Inventors: Martin G. Keen, Cary, NC (US); Jeremy Ray Fox, Georgetown, TX (US); Alexander Reznicek, Troy, NY (US); Bahman Hekmatshoartabari, White Plains, NY (US)

(21) Appl. No.: 18/772,457

(22) Filed: Jul. 15, 2024

(51) Int. Cl. G06N 5/022; G06N 5/04

(52) U.S. Cl. CPC G06N 5/022; G06N 5/04

(57) ABSTRACT

An embodiment for dynamic expertise profiling through historical prompt-driven refinement interactions is provided. The embodiment may include receiving historical prompts submitted by one or more users. The embodiment may also include extracting one or more features from the historical prompts. The embodiment may further include generating one or more metrics for the historical prompts. The embodiment may also include ranking the one or more users. The embodiment may further include creating one or more pairs of matched users. The embodiment may also include executing a validation workflow for the one or more pairs of matched users.

### BACKGROUND

The present invention relates generally to the field of computing, and more particularly to a system for dynamic expertise profiling through historical prompt-driven refinement interactions.

In today's rapidly evolving world, the ability to accurately identify and select experts in specific subject matter areas is crucial for informed decision making and problem solving. Experts play an important role in a wide variety of industries. For example, experts may teach in universities, conduct research, and deliver testimony in court cases. These experts may also be relied upon to verify the authenticity of written and spoken statements.

### SUMMARY

According to one embodiment, a method, computer system, and computer program product for dynamic expertise profiling through historical prompt-driven refinement interactions is provided. The method, computer system, and computer program product may include receiving historical prompts submitted by one or more users. The method, computer system, and computer program product may also include extracting one or more features from the historical prompts based on one or more executed actions. The method, computer system, and computer program product may further include generating one or more metrics for the historical prompts based on the extracted one or more features. The method, computer system, and computer program product may also include ranking the one or more users based on the generated one or more metrics. The method, computer system, and computer program product may further include creating one or more pairs of matched users based on the ranking. The method, computer system, and computer program product may also include executing a validation workflow for the one or more pairs of matched users.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for dynamic expertise profiling through historical prompt-driven refinement interactions in a dynamic expertise profiling process according to at least one embodiment.

FIG. 3 is an exemplary diagram depicting an interaction between solution components of the process in FIG. 2 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for dynamic expertise profiling through historical prompt-driven refinement interactions. The following described exemplary embodiments provide a system, method, and program product to, among other things, generate one or more metrics for historical prompts based on executed one or more actions and, accordingly, execute a validation workflow for one or more pairs of matched users. Therefore, the present embodiment has the capacity to improve expert selection and knowledge refinement technology by providing a more accurate and efficient method of identifying and selecting experts within specific subject matter areas.

As previously described, in today's rapidly evolving world, the ability to accurately identify and select experts in specific subject matter areas is crucial for informed decision making and problem solving. Experts play an important role in a wide variety of industries. For example, experts may teach in universities, conduct research, and deliver testimony in court cases. These experts may also be relied upon to verify the authenticity of written and spoken statements. Traditional methods of expert selection often lack objectivity and fail to capture the evolving expertise of individuals. This problem is typically addressed by making recommendations to users such as documents of interest and peers with whom the users may want to connect. However, making recommendations to users fails to rigorously profile and score experts based on complex and accurate historical prompts and fails to enable collaborative validation among recognized experts.

It may, therefore, be imperative to provide a method, system, and computer program product for objectively and accurately identifying trusted experts based on their evolving expertise.

According to at least one embodiment, a computer-based method, computer system, and computer program product for dynamic expertise profiling through historical prompt-driven refinement interactions is provided. The method comprises receiving historical prompts submitted by one or more users, extracting one or more features from the historical prompts based on one or more executed actions, generating one or more metrics for the historical prompts based on the extracted one or more features, ranking the one or more users based on the generated one or more metrics, creating one or more pairs of matched users based on the ranking, and executing a validation workflow for the one or more pairs of matched users. This embodiment has the advantage of ensuring accurate expert selection by leveraging historical prompts.

According to at least one embodiment, the method may further comprise determining whether a ranking of at least one user requires updating, and based on determining the ranking of the at least one user requires the updating, refining the ranking of the at least one user and at least one metric of the generated one or more metrics. This embodiment has the advantage of adaptively ranking expertise of the one or more users based on evolving criteria.

According to at least one embodiment, determining whether the ranking of the at least one user requires the updating may further comprise receiving an additional prompt in real-time from the at least one user, and refining the ranking of the at least one user based on the additional prompt. This embodiment has the advantage of dynamically adjusting expertise rankings as new data is introduced.

According to at least one embodiment, ranking the one or more users may further comprise computing a score for the one or more users based on the generated one or more metrics, and categorizing the one or more users into respective tiers based on the computed score. This embodiment has the advantage of consistently identifying the expertise of the one or more users in various industries.

According to at least one embodiment, the matched users in the one or more pairs may have a comparable level of expertise. This embodiment has the advantage of enabling interactions between users having a similar level of expertise.

According to at least one embodiment, executing the validation workflow for the one or more pairs of matched users may further comprise presenting the one or more pairs of matched users with a shared task based on the comparable level of expertise of the matched users, and prompting the matched users to submit feedback about each other relating to the comparable level of expertise. This embodiment has the advantage of enabling knowledge sharing between users having a similar level of expertise.

According to at least one embodiment, the extracted one or more features may include a word count of the historical prompts and one or more industry-specific terms used in the historical prompts, and generating one or more metrics for the historical prompts may further comprise computing a score measuring a complexity level and a relevance level of the historical prompts based on the word count and the one or more industry-specific terms. This embodiment has the advantage of providing a more efficient method of identifying experts within specific subject matter areas.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to generate one or more metrics for historical prompts based on executed one or more actions and, accordingly, execute a validation workflow for one or more pairs of matched users.

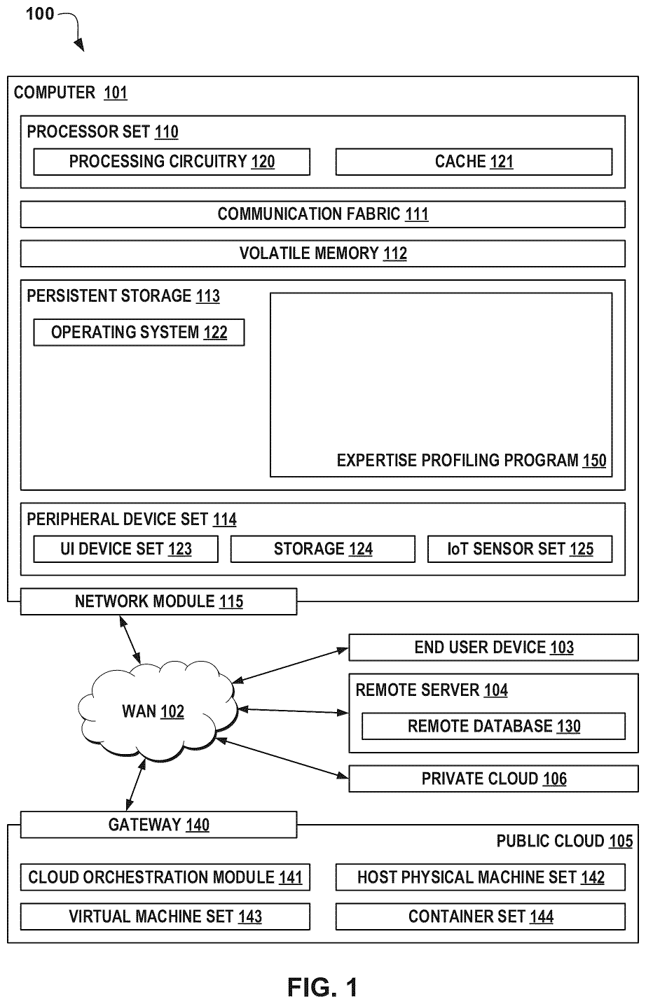

Referring to FIG. 1, an exemplary computing environment 100 is depicted, according to at least one embodiment. Computing environment 100 contains an example of an environment for the execution of at least some of the computer code involved in performing the inventive methods, such as an expertise profiling program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

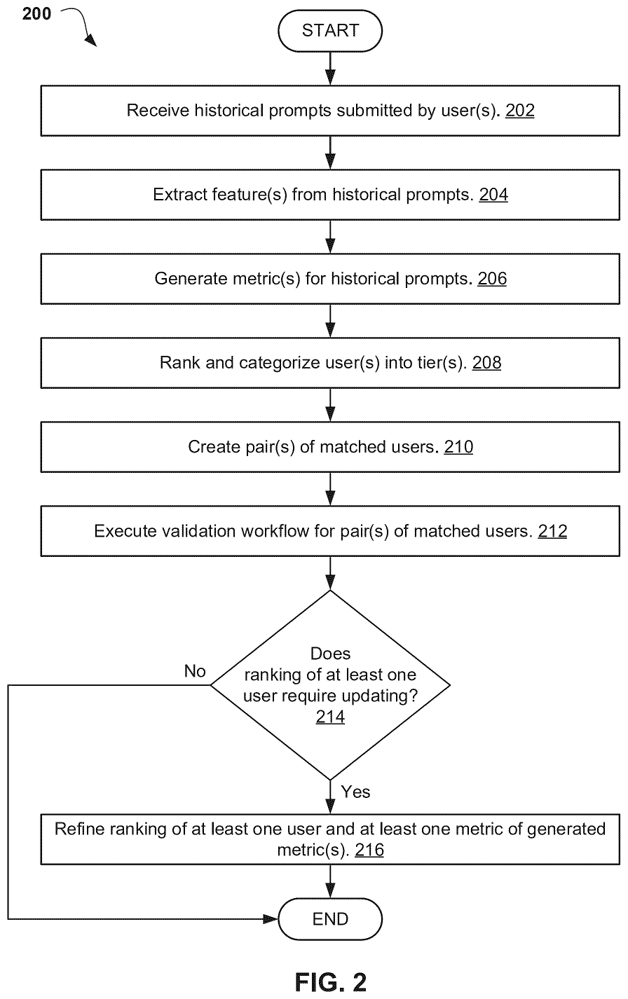

According to the present embodiment, the expertise profiling program 150 may be a program capable of receiving historical prompts submitted by one or more users, generating one or more metrics for the historical prompts based on executed one or more actions, and executing a validation workflow for one or more pairs of matched users. Furthermore, notwithstanding depiction in computer 101, the expertise profiling program 150 may be stored in and/or executed by, individually or in any combination, end user device 103, remote server 104, public cloud 105, and private cloud 106. The expertise profiling method is explained in further detail below with respect to FIG. 2. It may be appreciated that the examples described below are not intended to be limiting, and that in embodiments of the present invention the parameters used in the examples may be different.

Referring now to FIG. 2, an operational flowchart for dynamic expertise profiling through historical prompt-driven refinement interactions in a dynamic expertise profiling process 200 is depicted according to at least one embodiment. At 202, the expertise profiling program 150 receives the historical prompts submitted by the one or more users. The historical prompts may be submitted by the one or more users via a graphical user interface (GUI). The one or more users may include, but are not limited to, a subject matter expert (SME) that is world-renowned in a particular area (e.g., physics), someone who is not yet a world-renowned SME but is producing the content of an SME, and/or a novice user.

The historical prompts may include, but are not limited to, queries submitted by the one or more users and/or statements made by the one or more users. For example, a user may submit a query such as, “What is the acceleration due to gravity of a falling object?” In another example, the user may submit a statement such as, “The acceleration due to gravity of a falling object is 9.81 meters per second squared.” According to at least one embodiment, using Kafka real-time data streaming, the historical prompts may be ingested into a data lake.

Then, at 204, the expertise profiling program 150 extracts the one or more features from the historical prompts. The one or more features are extracted based on the one or more executed actions. Examples of the one or more features may include, but are not limited to, a word count of the historical prompts, one or more industry-specific terms used in the historical prompts, linguistic complexity of the historical prompts, subject matter relevance of the historical prompts, accuracy of the historical prompts, and/or any other features indicative of expertise. For example, the industry-specific term may be jargon in a particular subject matter area. Continuing the example, the user may submit, “What is the atomic number of Au,” where “Au” is gold. In this example, the use of “Au” may be an industry-specific term in the field of physics and chemistry. The one or more actions may be executed on the historical prompts to extract the one or more features. The historical prompts may be preprocessed using one or more natural language processing (NLP) techniques.

According to at least one embodiment, the NLP techniques may include, but are not limited to, tokenization, stemming, lemmatization, Term Frequency-Inverse Document Frequency (TF-IDF), and/or latent semantic analysis.

For example, lemmatization may reduce different forms of a word to a singular form, such as reducing “builds,” “building,” or “built” to the singular form “build.” The use of TF-IDF may assist in weighing the importance of words within prompts. Additionally, latent semantic analysis and word embeddings may capture a semantic meaning of the historical prompts.

Next, at 206, the expertise profiling program 150 generates the one or more metrics for the historical prompts. The one or more metrics are generated based on the extracted one or more features. As described above with respect to step 204, the extracted one or more features may include the word count of the historical prompts, the one or more industry-specific terms used in the historical prompts, the linguistic complexity of the historical prompts, the subject matter relevance of the historical prompts, and the accuracy of the historical prompts. The expertise profiling program 150 may generate the one or more metrics for the historical prompts using a random forest algorithm and/or support vector machines trained to classify historical prompts into different categories of expertise, described in further detail below with respect to step 208.

According to at least one embodiment, generating the one or more metrics for the historical prompts may include computing a score measuring the complexity level and the relevance level of the historical prompts based on the word count and the one or more industry-specific terms. The score may be directly proportional to expertise (e.g., the higher the score, the more expertise is associated with the historical prompts).

For example, fewer words may be indicative of expertise, since an expert user may be more concise in their historical prompts, whereas a novice user may be more verbose when submitting the historical prompts. Thus, where a first historical prompt of one user has 5 words, and a second historical prompt of another user has 10 words, the complexity and relevance score for the first historical prompt having 5 words may be higher than the complexity and relevance score for the second historical prompt having 10 words. Continuing the example, the complexity and relevance score for the first historical prompt may be 100, whereas the complexity and relevance score for the second historical prompt may be 50.

In another example, the more the industry specific terms are used, the higher the score will be for the complexity level and the relevance level. Continuing the example, where a first historical prompt includes the language “What is the acceleration due to gravity of a falling object,” and a second historical prompt includes the language “How fast does an object go when falling to the ground,” the complexity and relevance score for the first historical prompt may be higher than the complexity and relevance score for the second historical prompt, since “acceleration due to gravity” is an industry-specific term in physics. Continuing the example, the complexity and relevance score for the first historical prompt may be 100, whereas the complexity and relevance score for the second historical prompt may be 50.

According to at least one other embodiment, generating the one or more metrics for the historical prompts may include computing a score measuring the accuracy of the historical prompts. For example, the first historical prompt may include the language, “The acceleration due to gravity of a falling object is 9.81 meters per second squared,” and the second historical prompt may include the language, “The acceleration due to gravity of a falling object is 11 meters per second squared.” Continuing the example, since the first historical prompt is more accurate than the second historical prompt, the first historical prompt may have a higher score than the second historical prompt. Continuing the example, the first historical prompt may have an accuracy score of 100, whereas the second historical prompt may have an accuracy score of 70.

Then, at 208, the expertise profiling program 150 ranks the one or more users. The one or more users are ranked based on the generated one or more metrics. In order to rank the one or more users, the expertise profiling program 150 may assign a score to the one or more users.

According to at least one embodiment, ranking the one or more users may include computing a score for the one or more users based on the generated one or more metrics. Utilizing XGBoost, the one or more users may be scored based on the complexity, relevance, and/or accuracy of the historical prompts.

For example, where the complexity and relevance score for the first historical prompt of a first user containing 5 words is 100, and where the complexity and relevance score for the second historical prompt of a second user containing 10 words is 50, the score computed for the first user may be 100, and the score computed for the second user may be 50.

In another example, where the complexity and relevance score for the first historical prompt of a first user containing the language “What is the acceleration due to gravity of a falling object” is 100, and where the complexity and relevance score for the second historical prompt of a second user containing the language “How fast does an object go when falling to the ground” is 50, the score computed for the first user may be 100, and the score computed for the second user may be 50.

In a further example, where the accuracy score of the first historical prompt of a first user containing the language “The acceleration due to gravity of a falling object is 9.81 meters per second squared is 100”, and where the accuracy score of the second historical prompt of a second user containing the language “The acceleration due to gravity of a falling object is 11 meters per second squared” is 70, the score computed for the first user may be 100, and the score computed for the second user may be 70.

According to at least one other embodiment, ranking the one or more users may also include categorizing the one or more users into respective tiers based on the computed score. A machine learning algorithm, such as k-means clustering, may be utilized to classify these computed scores into pre-defined categories (e.g., tiers) of expertise. Examples of the tiers may include, but are not limited to, novice, intermediate, advanced, and/or expert. Each tier may be associated with a computed score. For example, a score between 0 and 25 may be associated with the novice tier, a score between 26 and 50 may be associated with the intermediate tier, a score between 51 and 75 may be associated with the advanced tier, and a score between 76 and 100 may be associated with the expert tier. Continuing the example, where the computed score for the first user is 100 and the computed score for the second user is 70, the first user may be categorized into the expert tier, and the second user may be categorized into the advanced tier.

Next, at 210, the expertise profiling program 150 creates the one or more pairs of matched users. The one or more pairs of matched users are created based on the ranking. The matched users in the one or more pairs may have a comparable level of expertise. Using graph-based algorithms such as community detection or nearest-neighbor, the expertise profiling program 150 may match users for collaborative validation.

According to at least one embodiment, the matched users in the one or more pairs may have a comparable level of expertise when the matched users are in the same tier. For example, where a first user and a second user are both in the expert tier, the first user and the second user may be matched.

According to at least one other embodiment, the matched users in the one or more pairs may have a comparable level of expertise when the matched users are in the same tier or an adjacent tier. Adjacent tiers may be as follows: novice and intermediate; intermediate and advanced; and advanced and expert. Since one or more tiers may have no users or an odd number of users, it may not be possible to create the one or more pairs of matched users in the same tier. For example, where the expert tier includes a first user, a second user, and a third user, one of those users cannot be matched to another user. Thus, at least one user may be matched to another user in an adjacent tier. Continuing the example, where the expert tier includes a first user, a second user, and a third user, and the advanced tier includes a fourth user, the first user and the second user may be matched, and the third user and the fourth user may also be matched.

Then, at 212, the expertise profiling program 150 executes the validation workflow for the one or more pairs of matched users. The validation workflow may enable the one or more pairs of matched users to corroborate each other's level of expertise. Executing the validation workflow for the one or more pairs of matched users may include presenting the one or more pairs of matched users with a shared task based on the comparable level of expertise of the matched users. For example, two expert users who are matched may be presented with the shared task via the GUI.

According to at least one embodiment, the shared task may include document review. For example, the one or more pairs of matched users may be prompted to review a research paper. The complexity of the research paper may vary depending on the level of expertise of the matched users. For example, matched users in the novice tier may review the research paper of a high school student, whereas matched users in the expert tier may review the research paper of a PhD candidate.

According to at least one other embodiment, the shared task may include contributing to a mini-project. For example, the one or more pairs of matched users may be prompted to participate in a virtual lab experiment. The complexity of the lab experiment may vary depending on the level of expertise of the matched users. For example, matched users in the novice tier may participate in a lab experiment at the high school level, whereas matched users in the expert tier may participate in a lab experiment at the graduate school level.

According to at least one further embodiment, the shared task may include question-answering rounds. For example, the one or more pairs of matched users may be prompted to take a pop quiz. The complexity of the pop quiz may vary depending on the level of expertise of the matched users. For example, matched users in the novice tier may take a pop quiz at the high school level, whereas matched users in the expert tier may take a pop quiz at the graduate school level.

In any of the embodiments described above, after each validation task, the matched users may be prompted to submit feedback about each other relating to the comparable level of expertise. For example, where the matched users include a first user and a second user, the first user may provide feedback about the second user, and the second user may provide feedback about the first user. The feedback may be used to either validate or refine the ranking of each user in the one or more pairs of matched users, described in further detail below with respect to steps 214 and 216. Sentiment scores may be used to quantify the feedback. For example, a score of 1 may indicate positive feedback (e.g., that validates the ranking of at least one user) and a score of 0 may indicate negative feedback (e.g., that the ranking of the at least one user needs to be refined).

Next, at 214, the expertise profiling program 150 determines whether the ranking of the at least one user requires the updating.

According to at least one embodiment, the determination may be made based on real-time prompts submitted by the one or more users. An additional prompt may be received in real-time from the at least one user. Thus, in addition to historical prompts, the user may submit additional prompts in real-time on an ongoing basis. The ranking of the at least one user may then be refined based on the additional prompt. A Bayesian updating framework may dynamically adjust expertise scores of the at least one user as new data is received. Over time, the rankings of the at least one user may evolve due to a variety of reasons. For example, a user may evolve from being in the novice tier to the intermediate tier or higher. Contrarily, a user may evolve from being in the expert tier to the advanced tier or lower, due to an expert user failing to keep up with new developments in a particular field.

According to at least one other embodiment, the determination may be made based on the feedback described above with respect to step 212. Based on determining the feedback is positive feedback, the at least one user may maintain their ranking or upgrade to the next tier. For example, where the first user and the second user are in the expert tier, and the first user provides positive feedback about the second user, the ranking of the second user may be maintained. In another example, where the first user and the second user are in the advanced tier, and the first user provides positive feedback about the second user, the ranking of the second user may be upgraded to the expert tier. Based on determining the feedback is negative feedback, the at least one user may be downgraded to a lower tier. For example, where the first user and the second user are in the expert tier, and the first user provides negative feedback about the second user, the ranking of the second user may be downgraded to the advanced tier.

Based on determining the ranking of the at least one user requires the updating (step 214, “Yes” branch), the dynamic expertise profiling process 200 proceeds to step 216 to refine the ranking of the at least one user and the at least one metric of the generated one or more metrics. Based on determining the ranking of the at least one user does not require the updating (step 214, “No” branch), the dynamic expertise profiling process 200 ends.

Then, at 216, the expertise profiling program 150 refines the ranking of the at least one user and the at least one metric of the generated one or more metrics. As described above with respect to step 214, the ranking may be refined based on feedback as well as real-time prompts. For example, when a user evolves from being in the novice tier to the intermediate tier, the ranking of the user may be changed to the intermediate tier. Contrarily, when a user evolves from being in the expert tier to the advanced tier, the ranking of the user may be changed to the advanced tier. In another example, where the first user and the second user are in the advanced tier, and the first user provides positive feedback about the second user, the ranking of the second user may be upgraded to the expert tier based on the positive feedback. Contrarily, where the first user and the second user are in the expert tier, and the first user provides negative feedback about the second user, the ranking of the second user may be downgraded to the advanced tier based on the negative feedback. The updated rankings may then be prepared for external consumption, such as by inputting the updated rankings into a database, such as remote database 130.

According to at least one embodiment, the at least one metric of the generated one or more metrics may be refined to reflect the updates to the ranking of the at least one user. For example, when the ranking of the at least one user is downgraded from the expert tier to the advanced tier, the at least one metric may be changed to reflect the at least one user has been moved to the advanced tier. Continuing the example, where the complexity and relevance score for the first historical prompt is 100, and that score led to the at least one user being categorized as an expert, the complexity and relevance score may be lowered to a range within the advanced tier (e.g., 51-75). In another example, when the ranking of the at least one user is upgraded from the advanced tier to the expert tier, the at least one metric may be changed to reflect the at least one user has been moved to the expert tier. Continuing the example, where the complexity and relevance score for the first historical prompt is 70, and that score led to the at least one user being categorized as advanced, the complexity and relevance score may be raised to a range within the expert tier (e.g., 76-100).

The refined at least one metric may then be fed to a machine learning model, such as the XGBoost model that scores the one or more users and/or Tensor Flow. For example, the updated complexity and relevance score of 60 may be fed to the machine learning model to adjust the weights of the machine learning model such that the output of the machine learning model is consistent with the new complexity and relevance score of 60. In this example, the output of the machine learning model may rank the at least one user as being in the advanced tier. In another example, the updated complexity and relevance score of 80 may be fed to the machine learning model to adjust the weights of the machine learning model such that the output of the machine learning model is consistent with the new complexity and relevance score of 80. In this example, the output of the machine learning model may rank the at least one user as being in the expert tier. Therefore, reinforcement learning may be used to continuously optimize the scoring metrics. It may be appreciated that in embodiments of the present invention, each time the at least one metric is refined, the updated values may be fed to the machine learning model to dynamically update the weights of the model.

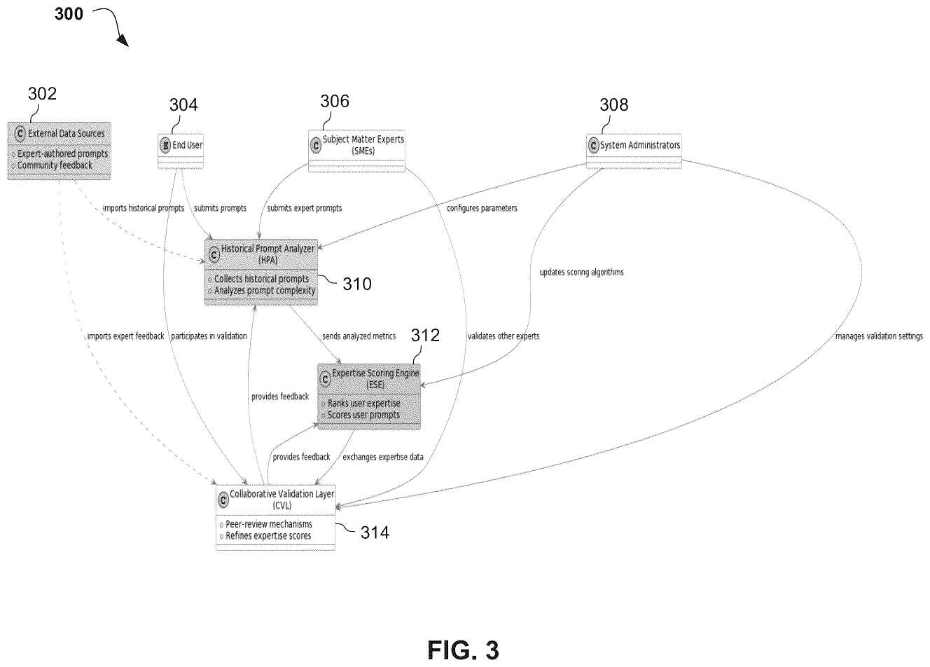

Referring now to FIG. 3, an exemplary diagram 300 depicting an interaction between solution components of the process in FIG. 2 is shown according to at least one embodiment. In the diagram 300, an external data sources module 302 may store the historical prompts and community feedback. An end user module 304 and a subject matter expert (SME) module 306 may receive real-time prompts from end users who are not yet experts and subject matter experts, respectively. A system administrators module 308 may configure parameters (e.g., features to be extracted) and update scoring algorithms. The historical prompts from the external data sources module 302, the real-time prompts from the end user module 304 and the SME module 306, and the parameters from the system administrators module 308 may be sent to a historical prompt analyzer (HPA) module 310 to collect the historical prompts and analyze prompt complexity. The HPA module 310 may send the analyzed prompt metrics to an expertise scoring engine module 312 to rank the expertise of the one or more users or alternatively score the real-time and historical prompts. The expertise scoring engine module 312 may also receive the updated scoring algorithms from the system administrators module 308 to assist in ranking the one or more users. The expertise scoring engine module 312 may send the expertise data to a collaborative validation layer module 314 which may implement the peer-review mechanisms and refine expertise scores. The HPA module 310 may receive feedback from the collaborative validation layer module 314 to improve feature extraction. The expertise scoring engine module 312 may exchange data with the collaborative validation layer module 314 for mutual validation and scoring metrics refinement. Finally, the collaborative validation layer module 314 may provide feedback to both the HPA module 310 and the expertise scoring engine module 312 to improve the machine learning models.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of dynamic expertise profiling through historical prompt-driven refinement interactions, the method comprising:
receiving historical prompts submitted by one or more users;
extracting one or more features from the historical prompts based on one or more executed actions;
generating one or more metrics for the historical prompts based on the extracted one or more features;
ranking the one or more users based on the generated one or more metrics;
creating one or more pairs of matched users based on the ranking; and
executing a validation workflow for the one or more pairs of matched users.

2. The computer-based method of claim 1, further comprising:
determining whether a ranking of at least one user requires updating; and
based on determining the ranking of the at least one user requires the updating, refining the ranking of the at least one user and at least one metric of the generated one or more metrics.

3. The computer-based method of claim 2, wherein determining whether the ranking of the at least one user requires the updating further comprises:
receiving an additional prompt in real-time from the at least one user; and
refining the ranking of the at least one user based on the additional prompt.

4. The computer-based method of claim 1, wherein ranking the one or more users further comprises:
computing a score for the one or more users based on the generated one or more metrics; and
categorizing the one or more users into respective tiers based on the computed score.

5. The computer-based method of claim 1, wherein the matched users in the one or more pairs have a comparable level of expertise.

6. The computer-based method of claim 5, wherein executing the validation workflow for the one or more pairs of matched users further comprises:
presenting the one or more pairs of matched users with a shared task based on the comparable level of expertise of the matched users; and
prompting the matched users to submit feedback about each other relating to the comparable level of expertise.

7. The computer-based method of claim 1, wherein the extracted one or more features include a word count of the historical prompts and one or more industry-specific terms used in the historical prompts, and wherein generating one or more metrics for the historical prompts further comprises:
computing a score measuring a complexity level and a relevance level of the historical prompts based on the word count and the one or more industry-specific terms.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving historical prompts submitted by one or more users;
extracting one or more features from the historical prompts based on one or more executed actions;
generating one or more metrics for the historical prompts based on the extracted one or more features;
ranking the one or more users based on the generated one or more metrics;
creating one or more pairs of matched users based on the ranking; and
executing a validation workflow for the one or more pairs of matched users.

9. The computer system of claim 8, the method further comprising:
determining whether a ranking of at least one user requires updating; and
based on determining the ranking of the at least one user requires the updating, refining the ranking of the at least one user and at least one metric of the generated one or more metrics.

10. The computer system of claim 9, wherein determining whether the ranking of the at least one user requires the updating further comprises:
receiving an additional prompt in real-time from the at least one user; and
refining the ranking of the at least one user based on the additional prompt.

11. The computer system of claim 8, wherein ranking the one or more users further comprises:
computing a score for the one or more users based on the generated one or more metrics; and
categorizing the one or more users into respective tiers based on the computed score.

12. The computer system of claim 8, wherein the matched users in the one or more pairs have a comparable level of expertise.

13. The computer system of claim 12, wherein executing the validation workflow for the one or more pairs of matched users further comprises:
presenting the one or more pairs of matched users with a shared task based on the comparable level of expertise of the matched users; and
prompting the matched users to submit feedback about each other relating to the comparable level of expertise.

14. The computer system of claim 8, wherein the extracted one or more features include a word count of the historical prompts and one or more industry-specific terms used in the historical prompts, and wherein generating one or more metrics for the historical prompts further comprises:
computing a score measuring a complexity level and a relevance level of the historical prompts based on the word count and the one or more industry-specific terms.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving historical prompts submitted by one or more users;
extracting one or more features from the historical prompts based on one or more executed actions;
generating one or more metrics for the historical prompts based on the extracted one or more features;
ranking the one or more users based on the generated one or more metrics;
creating one or more pairs of matched users based on the ranking; and
executing a validation workflow for the one or more pairs of matched users.

16. The computer program product of claim 15, the method further comprising:
determining whether a ranking of at least one user requires updating; and
based on determining the ranking of the at least one user requires the updating, refining the ranking of the at least one user and at least one metric of the generated one or more metrics.

17. The computer program product of claim 16, wherein determining whether the ranking of the at least one user requires the updating further comprises:
receiving an additional prompt in real-time from the at least one user; and
refining the ranking of the at least one user based on the additional prompt.

18. The computer program product of claim 15, wherein ranking the one or more users further comprises:
computing a score for the one or more users based on the generated one or more metrics; and
categorizing the one or more users into respective tiers based on the computed score.

19. The computer program product of claim 15, wherein the matched users in the one or more pairs have a comparable level of expertise.

20. The computer program product of claim 19, wherein executing the validation workflow for the one or more pairs of matched users further comprises:
presenting the one or more pairs of matched users with a shared task based on the comparable level of expertise of the matched users; and
prompting the matched users to submit feedback about each other relating to the comparable level of expertise.
